(19) United States
(12) Patent Application Publication
(10) Pub. No.: US 2012/0300680 A1
(43) Pub. Date: Nov. 29, 2012

(54) TRANSMISSION SCHEMES FOR RELAY

(75) Inventors: Christian Pietsch, Nuremberg (DE); Stefan Brueck, Neunkirchen am Brand (DE)

(73) Assignee: QUALCOMM Incorporated, San Diego, CA (US)

(21) Appl. No.: 13/480,368

(22) Filed: May 24, 2012

Related U.S. Application Data
(60) Provisional application No. 61/491,108, filed on May 27, 2011.

(51) Int. Cl. H04W 88/04

(52) U.S. Cl. 370/279; 370/315

(57) ABSTRACT

Techniques for processing and forwarding transmissions by a relay are disclosed. In one aspect, an orthogonal distributed space-time frequency code (DSTFC) scheme that supports full-duplex relay operation and mitigates self-interference is disclosed. With the orthogonal DSTFC scheme, a source node transmits a same modulation symbol on two subcarriers in one symbol period. The relay obtains two received symbols from the two subcarriers and generates two output symbols based on these received symbols such that the output symbols and the modulation symbol are orthogonal at the relay and a destination node. In another aspect, a distributed Alamouti scheme is disclosed in which the source node transmits two modulation symbols on two subcarriers in each of two consecutive symbol periods. The relay obtains two received symbols from the two subcarriers in one symbol period and generates two output symbols based on the received symbols and in accordance with an Alamouti code.

The present application claims priority to provisional U.S. Application Ser. No. 61/491,108, entitled “SIGNAL PROCESSING FOR FULL-DUPLEX RELAY,” filed May 27, 2011, and incorporated herein by reference in its entirety.

### BACKGROUND

I. Field

The present disclosure relates generally to communication, and more specifically to techniques for wireless communication.

II. Background

Wireless communication networks are widely deployed to provide various communication services such as voice, video, packet data, messaging, broadcast, etc. These wireless networks may be capable of supporting communication for multiple users by sharing the available network resources. Examples of such wireless networks include wireless wide area networks (WWANs) providing communication coverage for large geographic areas, wireless metropolitan area networks (WMANs) providing communication coverage for medium geographic areas, and wireless local area networks (WLANs) providing communication coverage for small geographic areas.

It may be desirable to improve the coverage of a wireless network. This may be achieved by using radio frequency (RF) repeaters. An RF repeater may receive an RF signal, amplify the received RF signal, and transmit the amplified RF signal. By amplifying the received RF signal, however, interference elements may be amplified as well. Furthermore, noise from circuitry within the RF repeater may be injected in the amplified RF signal and may degrade the desired signal. RF repeaters may thus improve link budget but may cause a loss in network capacity.

### SUMMARY

Techniques for processing and forwarding transmissions by a relay are disclosed herein. In one aspect, an orthogonal distributed space-time frequency code (DSTFC) scheme may be used to support full-duplex operation and to mitigate self-interference at the relay. In the orthogonal DSTFC scheme, a source node (e.g., a base station) may transmit the same modulation symbol on two subcarriers in one symbol period. The relay may obtain two received symbols from the two subcarriers in the symbol period and may generate two output symbols based on the two received symbols such that the output symbols and the modulation symbol are orthogonal at both the relay and a destination node (e.g., a user equipment).

In another aspect, a distributed Alamouti scheme across frequency may be used to support half-duplex and/or full-duplex operation by the relay. In the distributed Alamouti scheme, the source node may transmit two modulation symbols on two subcarriers in each of two consecutive symbol periods. The relay may obtain two received symbols from the two subcarriers in the first symbol period and may generate two output symbols based on the two received symbols and in accordance with an Alamouti code. The relay may transmit the two output symbols on the two subcarriers in the next symbol period.

In one aspect, the relay may obtain received symbols from a plurality of subcarriers in a first symbol period. The relay may generate output symbols based on the received symbols, without demodulating or decoding the received symbols. The relay may generate the output symbols based on the orthogonal DSTFC scheme or the distributed Alamouti scheme, as described herein. The relay may transmit the output symbols on the plurality of subcarriers in a second symbol period.

In one aspect, the destination node may obtain first received symbols from the plurality of subcarriers in the first symbol period. The destination node may also obtain second received symbols from the plurality of subcarriers in the second symbol period. The first and second received symbols may comprise (i) modulation symbols transmitted on the plurality of subcarriers by the source node and (ii) output symbols transmitted on the plurality of subcarriers by the relay. The destination node may process the first and second received symbols to recover data sent in the modulation symbols by the source node.

Various additional aspects and features of the disclosure are described in further detail below.

### BRIEF DESCRIPTION OF THE DRAWINGS

FIG. 1 shows a wireless communication network.

FIG. 2 illustrates aspects of an orthogonal DSTFC scheme.

FIGS. 3 and 4 illustrate aspects of a distributed Alamouti scheme for a half-duplex mode and a full-duplex mode, respectively.

FIG. 5 shows exemplary performance data for the transmission schemes depicted in FIGS. 2 to 4.

FIG. 6 shows a process for relaying transmissions by a relay.

FIG. 7 shows a process for receiving transmissions by a destination node.

FIGS. 8 and 9 show block diagrams including a source node, a relay, and a destination node.

### DETAILED DESCRIPTION

The techniques described herein may be used for various wireless communication networks such as WWANs, WMANs, WLANs, etc. The terms “network” and “system” are often used interchangeably. A WWAN may be a Code Division Multiple Access (CDMA) network, a Time Division Multiple Access (TDMA) network, a Frequency Division Multiple Access (FDMA) network, an Orthogonal FDMA (OFDMA) network, a Single-Carrier FDMA (SC-FDMA) network, etc. A CDMA network may implement a radio technology such as Universal Terrestrial Radio Access (UTRA), cdma2000, etc. UTRA includes Wideband CDMA (WCDMA), Time Division Synchronous CDMA (TD-SCDMA), and other variants of CDMA. cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.20, Flash-OFDM®, etc. UTRA and E-UTRA are part of Universal Mobile Telecommunication System (UMTS). 3GPP Long Term Evolution (LTE) and LTE-Advanced (LTE-A), in both frequency division duplexing (FDD) and time division duplexing (TDD), are recent releases of UMTS that use E-UTRA, which employs OFDMA on the downlink and SC-FDMA on the uplink. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). A WLAN may implement one or more standards in the IEEE 802.11 family of standards (which is also referred to as Wi-Fi and Wi-Fi Direct), Hiperlan, etc. A WMAN may implement one or more standards in the IEEE 802.16 family of standards (which is also referred to as WiMAX). The techniques described herein may be used for the wireless networks and radio technologies mentioned above as well as other wireless networks and radio technologies.

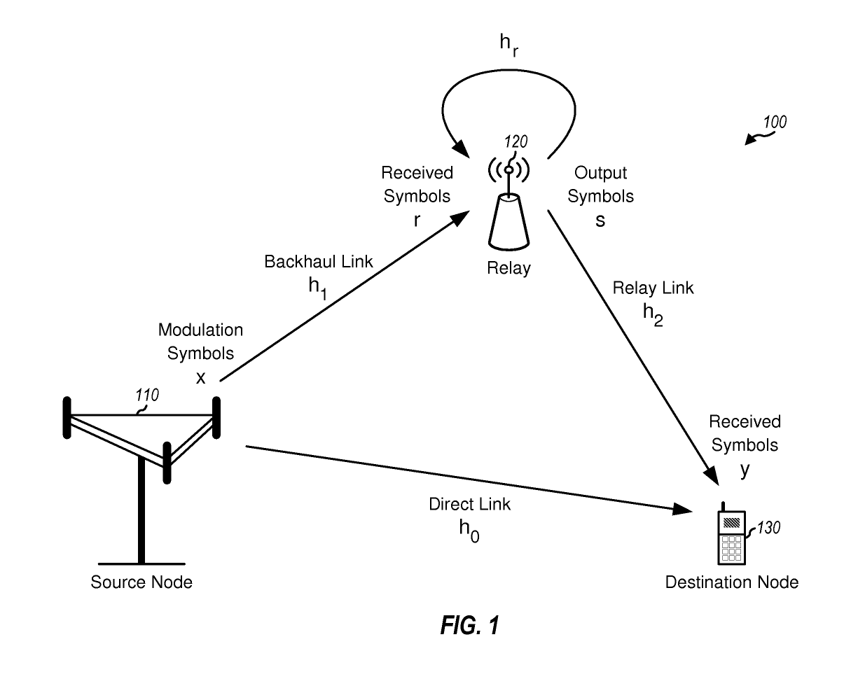

FIG. 1 shows a wireless communication network 100, which may be an LTE network or some other wireless network. For simplicity, only one source node 110, one relay 120, and one destination node 130 are shown in FIG. 1. In general, a wireless network may include any number of entities of each type.

Source node 110 may be a base station that communicates with user equipments (UEs), a broadcast station that broadcasts information, or some other transmitter station. A base station may also be referred to as a Node B, an evolved Node B (eNB), an access point, a node, etc.

Relay 120 may be a station that receives transmissions from a source node (e.g., source node 110) and forwards transmissions to a destination node (e.g., destination node 130). Relay 120 may be deployed for a specific purpose to receive and forward transmissions for other nodes. Relay 120 may also be a UE that can receive and forward transmissions for other nodes (e.g., other UEs).

Destination node 130 may be a UE, a broadcast receiver, or some other receiver station. A UE may also be referred to as a mobile station, a terminal, an access terminal, a subscriber unit, a station, a node, etc. A UE may be a cellular phone, a smartphone, a tablet, a wireless communication device, a personal digital assistant (PDA), a wireless modem, a handheld device, a laptop computer, a cordless phone, a wireless local loop (WLL) station, a netbook, a smartbook, etc. Destination node 130 may receive transmissions from source node 110 and may also send transmissions to source node 110. Destination node 130 may receive transmissions from relay 120 (with or without knowledge of destination node 130) and may also send transmissions to relay 120.

As shown in FIG. 1, source node 110 may send a transmission to destination node 130 via a direct link, which may also be referred to as a source-destination link. This transmission may also be received by relay 120 via a backhaul link, which may also be referred to as a source-relay link. Relay 120 may send a transmission to destination node 130 via a relay link, which may also be referred to as a relay-destination link. The direct link between source node 110 and destination node 130 may include a downlink and an uplink. The downlink may refer to a communication link from source node 110 to destination node 130, and the uplink may refer to a communication link from destination node 130 to source node 110. The backhaul link and the relay link may each include a downlink and an uplink. For simplicity, only the downlink between each pair of nodes is shown in FIG. 1, and the uplink is not shown in FIG. 1. Most of the description below refers to the downlink unless noted otherwise.

Wireless network 100 may utilize orthogonal frequency division multiplexing (OFDM) and/or single-carrier frequency division multiplexing (SC-FDM) for transmission. For example, wireless network 100 may be an LTE network that utilizes OFDM for the downlink and SC-FDMA for the uplink. OFDM and SC-PDM partition a frequency range into multiple (N_{FET}) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (N_{FET}) may be dependent on the system bandwidth. For example, the subcarrier spacing may be 15 kilohertz (KHz), and N_{FFT} may be equal to 128, 256, 512, 1024 or 2048 for system bandwidth of 1.4, 3, 5, 10 or 20 megahertz (MHz), respectively.

In general, each node in FIG. 1 may be equipped with any number of transmit antennas and any number of receive antennas. For clarity, much of the description below assumes that each node is equipped with a single antenna for transmission and/or reception. In this case, the channel response between any two nodes may be characterized by a complex channel gain/coefficient for each subcarrier. A channel gain for a subcarrier for the direct link may be denoted as h₀. A channel gain for a subcarrier for the backhaul link may be denoted as h₁. A channel gain for a subcarrier for the relay link may be denoted as h₂. A channel gain for a subcarrier from a transmitter to a receiver within relay 120 may be denoted as hᵣ. The channel between any two nodes may be static and non-varying over time. Alternatively, the channel may be time variant, and a channel gain between two nodes for a subcarrier may be denoted as h_{m,i}, where mε{0, 1, 2, r}, and i is an index for time, e.g., symbol period. The frequency characteristic of the channel between any two nodes may be such that the channel gains of two adjacent subcarriers may be assumed to be equal.

Relay 120 may operate in a half-duplex (HD) mode and/or a full-duplex (FD) mode. In the half-duplex mode, relay 120 may either transmit or receive (but not both) at any given time. In the full-duplex mode, relay 120 may concurrently receive a transmission from source node 110 and send a transmission to destination node 130. The full-duplex mode may make better use of the available resources and hence may be more desirable than the half-duplex mode. More particularly, the half-duplex mode may use only the backhaul link or the relay link at any given time whereas the full-duplex mode may use both the backhaul link and the relay link simultaneously, thus potentially increasing efficiency by a factor of two. In full-duplex mode, relay 120 typically receives a superposition of a transmission from source node 110 and its own transmission to destination node 130. The disturbance observed by relay 120 due to its own transmission is typically referred to as self-interference. The self-interference may degrade performance.

In one aspect of the disclosure, an orthogonal DSTFC scheme may be used to support the full-duplex mode and to mitigate self-interference at relay 120. In the orthogonal DSTFC scheme, source node 110 may transmit the same modulation symbol on two subcarriers in one symbol period. Relay 120 may obtain two received symbols from the two subcarriers in the symbol period and may generate two output symbols based on the two received symbols such that the output symbols and the modulation symbol are orthogonal at both relay 120 and destination node 130. This orthogonality may reduce interference between the modulation symbol from source node 110 and the output symbols from relay 120. It may also enable relay 120 (and also destination node 130) to recover the modulation symbol from source node 110 as well as the output symbols from relay 120 with a relatively simple receiver, as described below.

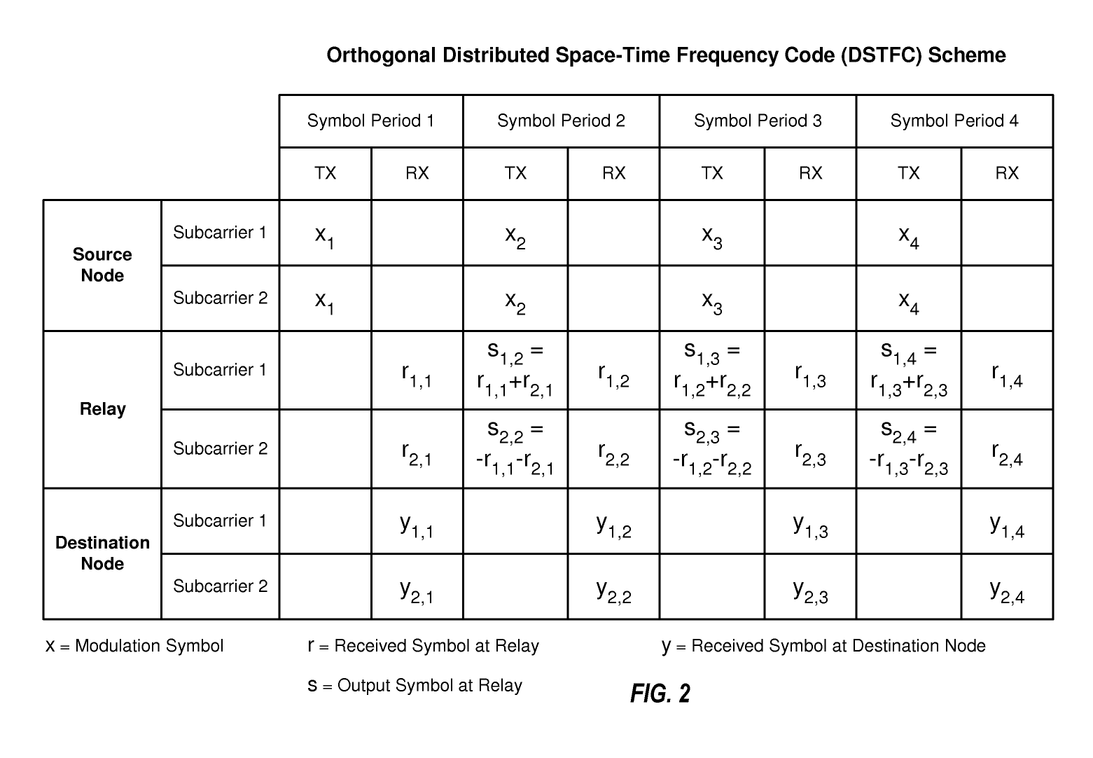

FIG. 2 illustrates operation of the disclosed orthogonal DSTFC scheme in the full-duplex mode. For simplicity, FIG. 2 shows transmitted symbols and received symbols on two subcarriers (Subcarrier 1, Subcarrier 2) in four symbol periods (Symbol Periods 1-4). In general, the orthogonal DSTFC scheme may be used for any number of subcarriers and any number of symbol periods.

As shown in FIG. 2, source node 110 may transmit the same modulation symbol xᵢ on the two subcarriers 1 and 2 in symbol period i, where i=1, 2, 3, 4. Relay 120 may obtain two received symbols r_{1,i} and r_{2,i} from the two subcarriers 1 and 2 in symbol period i. Relay 120 may generate two output symbols s_{1,i+1} and s_{2,i+1} based on the two received symbols r_{1,i} and r_{2,i}, as follows:

s_{1,i+1}=r_{1,i}+r_{2,i}, and Eq (1)

s_{2,i+1}=−r_{1,i}−r_{2,i}=−s_{1,i+1}. Eq (2)

As shown in equations (1) and (2), one output symbol s_{1,i+1} may be equal to the sum of the two received symbols, and the other output symbol s_{2,i+1} may be equal to the opposite of the sum of the two received symbols, i.e., the negative of s_{1,i±1}. Output symbols s_{1,i+1} and s_{2,i+1} may be scaled versions of modulation symbol xᵢ transmitted by source node 110, with the scaling being dependent on the channel gain of the backhaul link from source node 110 to relay 120. Relay 120 may transmit the two output symbols s_{1,i+1} and s_{2,i+1} on the two subcarriers in the next symbol period i+1 to destination node 130. Relay 120 may obtain two received symbols r_{1,i+1} and r_{2,i+1} on the two subcarriers 1 and 2 in symbol period i+1. These received symbols include self-interference from the two output symbols s_{1,i+1} and s_{2,i+1} transmitted by relay 120 on the two subcarriers in symbol period i+1. However, as shown, the self-interference on the two subcarriers differs by sign such that it may be canceled when relay 120 adds up the two received symbols r_{1,i+1} and r_{2,i+1} from the two subcarriers in symbol period i+1 to generate output symbols s_{1,i+2} and s_{2,i+2}, assuming that the channel gain is the same for both subcarriers. In this way, the self-interference terms may be canceled by the processing at relay 120, without the need to know the channel response and/or the self-interfering signal at the relay and also without the need for any active/self interference canceller at relay 120.

The orthogonal DSTFC scheme in FIG. 2 may operate to maintain orthogonality between the modulation symbols transmitted by source node 110 and the output symbols transmitted by relay 120 at relay 120. Relay 120 may obtain two received symbols r_{1,i} and r_{2,i} from two subcarriers 1 and 2 in symbol period i. These received symbols may be expressed as:

$$\begin{matrix}{r}_{1 , i} = {h}_{1} \cdot {x}_{i} + {h}_{r} \cdot {s}_{1 , i} + {n}_{r , 1} , \\ and & Eq ( 3 ) \\ \begin{matrix}{r}_{2 , i} = {h}_{1} \cdot {x}_{i} + {h}_{r} \cdot {s}_{2 , i} + {n}_{r , 2} \\ = {h}_{1} \cdot {x}_{i} - {h}_{r} \cdot {s}_{1 , i} + {n}_{r , 2}\end{matrix} & Eq ( 4 )\end{matrix}$$

where n_{r,1} and n_{r,2} denote the noise at relay 120 on subcarriers 1 and 2, respectively.

In equations (3) and (4), the term h₁·xᵢ denotes a desired signal component from source node 110 at relay 120. The terms hᵣ·s_{1,i} and hᵣ·s_{2,i} denote self-interference at relay 120 on subcarriers 1 and 2, respectively.

Relay 120 may recover modulation symbol xᵢ from source node 110 by summing the two received symbols (or r_{1,i}+r_{2,i}), which would result in the output symbols s_{1,i} and s_{2,i} canceling out. Relay 120 may also recover the output symbol s_{1,i} from relay 120 by subtracting the two received symbols (or r_{1,i}−r_{2,i}), which would result in modulation symbol xᵢ transmitted on the two subcarriers canceling out. The orthogonality between the modulation symbols transmitted by source node 110 and the output symbols transmitted by relay 120 can mitigate self-interference at relay 120 and reduce the amount of self-interference forwarded by relay 120 to destination node 130.

The orthogonal DSTFC scheme in FIG. 2 may also maintain orthogonality between the modulation symbols transmitted by source node 110 and the output symbols transmitted by relay 120 at destination node 130. Destination node 130 may obtain two received symbols y_{1,i} and y_{2,i} from two subcarriers 1 and 2 in symbol period i. These received symbols may be expressed as:

$$\begin{matrix}{y}_{1 , i} = {h}_{0} \cdot {x}_{i} + {h}_{2} \cdot {s}_{1 , i} + {n}_{d , 1} , \\ and & Eq ( 5 ) \\ \begin{matrix}{y}_{2 , i} = {h}_{0} \cdot {x}_{i} + {h}_{2} \cdot {s}_{2 , i} + {n}_{d , 2} \\ = {h}_{0} \cdot {x}_{i} - {h}_{2} \cdot {s}_{1 , i} + {n}_{d , 2}\end{matrix} & Eq ( 6 )\end{matrix}$$

where n_{d,1} and n_{d,2} denote the noise at destination node 130 on subcarriers 1 and 2, respectively.

In equations (5) and (6), the term h₀·xᵢ denotes a desired signal component from source node 110 at destination node 130. The terms h₂·s_{1,i} and h₂·s_{2,i} denote desired signal components from relay 120 at destination node 130 on subcarriers 1 and 2, respectively.

Destination node 130 may recover modulation symbol xᵢ from source node 110 by summing the two received symbols (or y_{1,i}+y_{2,i}), which would result in the output symbols s_{1,i} and s_{2,i} canceling out. Destination node 130 may also recover the output symbol s_{1,i} from relay 120 by subtracting the two received symbols (or y_{1,i}−y_{2,i}), which would result in modulation symbol xᵢ transmitted on the two subcarriers canceling out. The orthogonality between the modulation symbols transmitted by source node 110 and the output symbols transmitted by relay 120 enables destination node 130 to extract and combine the desired signal components from source node 110 and relay 120.

Destination node 130 may obtain two received symbols y_{1,i} and y_{2,i} from two subcarriers 1 and 2 in each symbol period. Destination node 130 may determine an estimate of modulation symbol xᵢ transmitted by source node 110 on both subcarriers 1 and 2 in symbol period i based on (i) received symbols y_{1,i} and y_{2,i} from subcarriers 1 and 2 in symbol period i and (ii) received symbols y_{1,i+1} and y_{2,i+1} from subcarriers 1 and 2 in the next symbol period i+1, as follows:

$${\hat{x}}_{i} = \frac{{h}_{0}^{*} \cdot ( {y}_{1 , i} + {y}_{2 , i} ) + {h}_{1}^{*} \cdot {h}_{2}^{*} \cdot ( {y}_{1 , i + 1} - {y}_{2 , i + 1} )}{{\vert {h}_{0} \vert}^{2} + {\vert {h}_{1} \vert}^{2} \cdot {\vert {h}_{2} \vert}^{2}} , \qquad Eq ( 7 )$$

where “*” denotes a complex conjugate. Channel gains h₀, h₁ and h₂ are for both subcarriers 1 and 2 for the direct link, the backhaul link, and the relay link, respectively.

In equation (7), the term y_{1,i}+y_{2,i} provides a first estimate of modulation symbol xᵢ based on the desired signal components from source node 110 at destination node 130. The term y_{1,i+1}−y_{2,i+1} provides an estimate of r_{1,i}+r_{2,i}, which corresponds to a second estimate of modulation symbol xᵢ based on the desired signal components from relay 120 at destination node 130. The two estimates of modulation symbol xᵢ are multiplied by appropriate channel gains, coherently combined, and scaled to obtain a final estimate of modulation symbol xᵢ.

The received symbols at relay 120 may be expressed as:

r=H₁x+Hᵣs+nᵣ, Eq (8)

where
H₁ is a 2L×2L channel matrix for the backhaul link on two subcarriers in L symbol periods,
Hᵣ is a 2L×2L channel matrix from the transmitter to the receiver within relay 120 on two subcarriers in L symbol periods,
x is a 2L×1 vector of modulation symbols transmitted on two subcarriers in L symbol periods by source node 110,
s is a 2L×1 vector of output symbols transmitted on two subcarriers in L symbol periods by relay 120,
r is a 2L×1 vector of received symbols from two subcarriers in L symbol periods at relay 120, and
nᵣ is a 2L×1 noise vector at relay 120.

Equation (8) shows a linear block transmission model in which transmissions are sent in blocks, with each block covering two subcarriers in L symbol periods. L may be equal to 1, 2, 4, or some other value. In general, a transmission may be sent in blocks or in a continuous manner. For a blocked transmission, vector x includes L pairs of modulation symbols transmitted in L symbol periods, with each pair including two identical modulation symbols transmitted on two subcarriers in one symbol period. Vector s includes L pairs of output symbols transmitted in L symbol periods, with each pair including two output symbols transmitted on two subcarriers in one symbol period. Vector r includes L pairs of received symbols in L symbol periods, with each pair including two received symbols from two subcarriers in one symbol period.

Channel matrix Hₘ, for mε{0, 1, 2, r}, may be expressed as:

$${H}_{m} = [ \begin{matrix}{h}_{m} & 0 & … & 0 \\ 0 & {h}_{m} & … & 0 \\ ⋮ & ⋮ & ⋱ & ⋮ \\ 0 & 0 & … & {h}_{m}\end{matrix} ] , \\ where \\ {h}_{m} = [ \begin{matrix}{h}_{m} & 0 \\ 0 & {h}_{m}\end{matrix} ] \qquad Eq ( 9 )$$

is a channel matrix for two subcarriers in one symbol period, and 0 is a matrix of all zeros. Channel matrices Hₘ and hₘ are diagonal matrices with possible non-zero elements along the diagonal and zeros elsewhere.

Equation (9) assumes a static channel in a block fading model, with the channel being constant for an entire block of L symbol periods. In this case, each diagonal element of matrix Hₘ may include matrix hₘ, and each diagonal element of matrix hₘ may include channel gain hₘ. The channel matrices for the direct link, the backhaul link, the relay link, and the transmit-to-receive path at relay 120 may then be expressed as H₀=h₀I, H₁=h₁I, H₂=h₂I, and Hᵣ=hᵣI, where I is an identity matrix of dimension 2L×2L. For a time-varying channel, the diagonal elements of matrix Hₘ may include matrices h_{m,i} through h_{m,i+L-1}, and each diagonal element of matrix h_{m,i} may include a channel gain h_{m,i} for one subcarrier in one symbol period i.

The processing at relay 120 may be expressed as:

s=Uᵣr, Eq (10)

where Uᵣ is a 2L×2L processing matrix for relay 120 for two subcarriers in L symbol periods.

Processing matrix Uᵣ for the case of L=4 may be expressed as:

$${U}_{r} = [ \begin{matrix}0 & 0 & 0 & 0 \\ {u}_{r} & 0 & 0 & 0 \\ 0 & {u}_{r} & 0 & 0 \\ 0 & 0 & {u}_{r} & 0\end{matrix} ] , \qquad Eq ( 11 )$$

where uᵣ is a 2×2 processing matrix for two subcarriers in two symbol periods. Processing matrix Uᵣ includes matrix uᵣ below the main diagonal due to a processing delay of one symbol period.

The output symbols in equation (10) may be expressed as:

$$\begin{matrix}s = {U}_{r} r \\ = {U}_{r} ( {H}_{r} s + {H}_{1} x + {n}_{r} ) \\ = {( I - {U}_{r} {H}_{r} )}^{- 1} {U}_{r} ( {H}_{1} x + {n}_{r} ) .\end{matrix} \qquad Eq ( 12 )$$

Equation (12) shows the output symbols from relay 120 with self-interference. The self-interference at relay 120 may be modeled as (I−Uᵣ Hᵣ)⁻¹. Relay 120 would observe no self-interference if Hᵣ=0, which would result in (I−Uᵣ Hᵣ)⁻¹Uᵣ=Uᵣ. If there is no self-interference at relay 120, then the output symbols may be expressed as:

s=Uᵣ(H₁x+nᵣ). Eq (13)

With processing matrix Uᵣ defined as shown in equation (11), self-interference would cancel out if Uᵣ Hᵣ Uᵣ=0. If relay 120 has one transmit antenna and hᵣ is a scalar, then self-interference would cancel out if uᵣ uᵣ=0. This condition may be satisfied by defining matrix uᵣ as follows:

Uᵣ=v₀v₁^{H}, Eq (14)

where
v₀ and v₁ are columns of a unitary matrix V, and
“^{H}” denotes a Hermitian or conjugate transpose.
   A unitary matrix V is a matrix having columns that are orthogonal to one another and unit magnitude for each column, so that V^{H} V=I.

If relay 120 has multiple transmit antennas and hᵣ is non-scalar, then matrix uᵣ may be defined as follows:

uᵣ=(v₀v₁^{H})\textcircled{x}Pᵣ, Eq (15)

where
Pᵣ is a spatial processing matrix (i.e., a precoding matrix) for relay 120, and
A\textcircled{x}B denotes multiplication of each element of matrix A with matrix B.

Matrix uᵣ may be defined based on various unitary matrices so that self-interference can be canceled out. In a first design, matrices uᵣ and V may be defined as follows:

$$\begin{matrix}V = ( {v}_{0} {v}_{1} ) = \frac{1}{\sqrt{2}} [ \begin{matrix}1 & 1 \\ - 1 & 1\end{matrix} ] , & Eq ( 16 ) \\ {u}_{r} = {v}_{0} {v}_{1}^{H} = \frac{1}{\sqrt{2}} [ \begin{matrix}1 & 1 \\ - 1 & - 1\end{matrix} ] , and & Eq ( 17 ) \\ [ \begin{matrix}{s}_{1 , i + 1} \\ {s}_{2 , i + 1}\end{matrix} ] = \frac{1}{\sqrt{2}} [ \begin{matrix}1 & 1 \\ - 1 & - 1\end{matrix} ] \cdot [ \begin{matrix}{r}_{1 , i} \\ {r}_{2 , i}\end{matrix} ] = \frac{1}{\sqrt{2}} [ \begin{matrix}{r}_{1 , i} + {r}_{2 , i} \\ - {r}_{1 , i} - {r}_{2 , i}\end{matrix} ] . & Eq ( 18 )\end{matrix}$$

The first design corresponds to the orthogonal DSTFC scheme shown in FIG. 2.

In the first design, processing matrix Uᵣ at relay 120 for the case of L=4 may be expressed as:

$${U}_{r} = \frac{1}{\sqrt{2}} [ \begin{matrix}0 & 0 & 0 & 0 & 0 & 0 & 0 & 0 \\ 0 & 0 & 0 & 0 & 0 & 0 & 0 & 0 \\ 1 & 1 & 0 & 0 & 0 & 0 & 0 & 0 \\ - 1 & - 1 & 0 & 0 & 0 & 0 & 0 & 0 \\ 0 & 0 & 1 & 1 & 0 & 0 & 0 & 0 \\ 0 & 0 & - 1 & - 1 & 0 & 0 & 0 & 0 \\ 0 & 0 & 0 & 0 & 1 & 1 & 0 & 0 \\ 0 & 0 & 0 & 0 & - 1 & - 1 & 0 & 0\end{matrix} ] . \qquad Eq ( 19 )$$

In a second design, matrices uᵣ and V may be defined as follows:

$$\begin{matrix}V = ( {v}_{0} {v}_{1} ) = [ \begin{matrix}1 & 0 \\ 0 & 1\end{matrix} ] , & Eq ( 20 ) \\ {u}_{r} = {v}_{0} {v}_{1}^{H} = [ \begin{matrix}0 & 1 \\ 0 & 0\end{matrix} ] , and & Eq ( 21 ) \\ [ \begin{matrix}{s}_{1 , i + 1} \\ {s}_{2 , i + 1}\end{matrix} ] = [ \begin{matrix}0 & 1 \\ 0 & 0\end{matrix} ] \cdot [ \begin{matrix}{r}_{1 , i} \\ {r}_{2 , i}\end{matrix} ] = [ \begin{matrix}{r}_{2 , i} \\ 0\end{matrix} ] . & Eq ( 22 )\end{matrix}$$

The second design corresponds to a transmission scheme in which source node 110 transmits a modulation symbol on one subcarrier (e.g., subcarrier 2). Relay 120 generates an output symbol based on a received symbol from this one subcarrier and transmits the output symbol on another subcarrier (e.g., subcarrier 1). Matrices uᵣ and V may also be defined based on other designs such that self-interference cancels out at relay 120. Since self-interference is not forwarded by relay 120, advantageously, there may be no need for complicated gain control of a transmission from relay 120.

Source node 110 may generate vector x as follows:

x=Uₛz, Eq (23)

where
z is a L×1 vector of modulation symbols transmitted in L symbol period, and
Uₛ is a 2L×L processing matrix for source node 110 for two subcarriers in L symbol periods.

If source node 110 includes one transmit antenna, then processing matrix Uₛ may be expressed as:

Uₛ=I\textcircled{x}v₁. Eq (24)

For example, if vector v₁ is defined as shown in equation (16) and L=4, then processing matrix Uₛ may be expressed as:

$${U}_{s} = [ \begin{matrix}1 & 0 & 0 & 0 \\ 1 & 0 & 0 & 0 \\ 0 & 1 & 0 & 0 \\ 0 & 1 & 0 & 0 \\ 0 & 0 & 1 & 0 \\ 0 & 0 & 1 & 0 \\ 0 & 0 & 0 & 1 \\ 0 & 0 & 0 & 1\end{matrix} ] . \qquad Eq ( 25 )$$

Processing matrix Uₛ in equation (25) corresponds to the orthogonal DSTFC scheme shown in FIG. 2.

If source node 110 includes multiple transmit antennas, then processing matrix Uₛ may be expressed as:

Uₛ=I\textcircled{x}v₁\textcircled{x}Pₛ, Eq (26)

where Pₛ is a spatial processing matrix (i.e., a precoding matrix) for source node 110.

The above equations indicate that vector v₁ is used by both source node 110 to generate modulation symbols and by relay 120 to generate output symbols. However, relay 120 further uses vector v₀ to obtain orthogonality. Processing matrix Uᵣ for relay 120 may be dependent on vector v₁ used by source node 110 and vector v₀ used by relay 120 to obtain orthogonality.

The received symbols at destination node 130 may be expressed as:

$$\begin{matrix}y = {H}_{0} x + {H}_{2} s + {n}_{d} \\ = {H}_{0} x + {{H}_{2} ( I - {U}_{r} {H}_{r} )}^{- 1} {U}_{r} ( {H}_{1} x + {n}_{r} ) + {n}_{d} \\ = ( {{H}_{2} ( I - {U}_{r} {H}_{r} )}^{- 1} {U}_{r} {H}_{1} + {H}_{0} ) x + \\ {{H}_{2} ( I - {U}_{r} {H}_{r} )}^{- 1} {U}_{r} {n}_{r} + {n}_{d} \\ = {H}_{eff} z + {n}_{eff}\end{matrix} \qquad Eq ( 27 )$$

where
y is a 2L×1 vector of received symbols at destination node 130,
n_{d} is a 2L×1 noise vector at destination node 130,
n_{eff} is a 2L×1 effective noise vector at destination node 130, and
H_{eff} is a 2L×2L effective channel matrix, which may be expressed as:

H_{eff}=(H₂(I−UᵣHᵣ)⁻¹UᵣH₁+H₀)Uₛ. Eq (28)

The effective channel matrix includes the direct link, the backhaul link, and the relay link. Vector y includes L pairs of received symbols in L symbol periods, with each pair including two received symbols from two subcarriers in one symbol period.

An estimated channel matrix Hₑₛₜ may be expressed as:

Hₑₛₜ=(H₂UᵣH₁+H₀)Uₛ. Eq (29)

Destination node 130 may determine the estimated channel matrix based on an estimate of H₀, an estimate of H₂ Uᵣ H₁, and known Uᵣ and Uₛ. Destination node 130 may estimate H₀ based on a reference signal or pilot sent by source node 110. Destination node 130 may estimate H₂ Uᵣ H₁ based on the reference signal sent by source node 110 and forwarded by relay 120, without requiring any special processing by relay 120. The estimated channel matrix may be equal to the effective channel matrix if there is no self-interference and Hᵣ=0. For simplicity, equation (29) assumes no channel estimation errors.

The product of the estimated channel matrix and the effective channel matrix, with no self-interference, may be expressed as:

$${H}_{est}^{H} {H}_{eff} = [ \begin{matrix}R & 0 & … & 0 & 0 \\ 0 & R & … & 0 & 0 \\ ⋮ & ⋮ & ⋱ & ⋮ & ⋮ \\ 0 & 0 & … & R & 0 \\ 0 & 0 & … & 0 & S\end{matrix} ] , \\ where R = [ \begin{matrix}{g}_{r} & 0 \\ 0 & {g}_{r}\end{matrix} ] , S = [ \begin{matrix}{g}_{s} & 0 \\ 0 & {g}_{s}\end{matrix} ] , \qquad Eq ( 30 )$$

and gᵣ and gₛ are scalars.

If source node 110 includes a single transmit antenna, then scalars gᵣ and gₛ may be expressed as:

gᵣ=|h₀|²+|h₁|²·|h₂|², and Eq (31)

gₛ=|h₀|². Eq (32)

If source node 110 and relay 120 include multiple transmit antennas, then scalars gᵣ and gₛ in matrices R and S may be replaced with matrices Gᵣ and Gₛ, which may be expressed as:

Gᵣ=Pₛ^{H}(h₀^{H}h₀+h₂^{H}Pᵣ^{H}h₁^{H}h₁Pᵣh₂)Pₛ, and Eq (33)

Gₛ=Pₛ^{H}(h₀^{H}h₀)Pₛ, Eq (34)

where h₀, h₁ and h₂ are channel vectors or matrices for the direct link, the backhaul link, and the relay link, respectively.

As shown in equation (30), the product Hₑₛₜ^{H} H_{eff} is a diagonal matrix that includes L−1 matrices R and one matrix S along the diagonal when there is no self-interference. Hₑₛₜ^{H} H_{eff} indicates that destination node 130 may receive the last modulation symbol from only source node 110 (due to a block transmission model) and may receive other modulation symbols from both source node 110 and relay 120.

The received symbols at destination node 130 may be processed in various manners to obtain estimates of the modulation symbols transmitted by source node 110. In one design, a matched filter M_{mf} may be defined based on the estimated channel matrix, as follows:

M_{mf}=Hₑₛₜ^{H}. Eq (35)

Matched filtering may be performed on the received symbols at destination node 130, as follows:

\hat{x}_{mf}=M_{mf}y, Eq (36)

where \hat{x}_{mf} is a L×1 vector of detected symbols in L symbol periods. The detected symbols are estimates of the modulation symbols transmitted in L symbol periods.

Since Hₑₛₜ^{H} H_{eff} is a diagonal matrix, matched filtering may ensure that there is no crosstalk between different modulation symbols and a symbol-wise detector returns a maximum likelihood (ML) decision. A low complexity ML detector may thus be implemented with a matched filter followed by a symbol-wise detector.

In another design, a minimum mean square error (MMSE) filter Mₘₘₛₑ may be defined based on the estimated channel matrix, as follows:

Mₘₘₛₑ=(Hₑₛₜ^{H}Hₑₛₜ+E{n_{eff}n_{eff}^{H}})⁻¹Hₑₛₜ^{H}, Eq (37)

where E{ } denotes an expectation.

The effective noise n_{eff} may be expressed as:

n_{eff}=H₂(I−UᵣHᵣ)⁻¹Uᵣnᵣ+n_{d}. Eq (38)

Destination node 130 may be informed of the noise nᵣ at relay 120 and may compute the effective noise n_{eff} based on its noise n_{d} and the relay noise nᵣ. If the relay noise is not available, then destination node 130 may compute E{n_{d} n_{d}^{H}} based on its noise n_{d} and may use E{n_{d} n_{d}^{H}} to compute the MMSE filter.

MMSE filtering may be performed on the received symbols at destination node 130, as follows:

\hat{x}ₘₘₛₑ=MₘₘₛₑY, Eq (39)

where is \hat{x}ₘₘₛₑ a L×1 vector of detected symbols in L symbol periods.

In another aspect of the disclosure, a distributed Alamouti scheme across frequency may be used to support the half-duplex mode. In this transmission scheme, source node 110 may transmit two modulation symbols on two subcarriers in each of two consecutive symbol periods. Relay 120 may obtain two received symbols from the two subcarriers in the first of the two symbol periods and may generate two output symbols based on the received symbols and in accordance with an Alamouti code. Relay 120 may then transmit the two output symbols on the two subcarriers in the second of the two symbol periods. The output symbols may also be referred to as Alamouti-encoded symbols.

In the distributed Alamouti scheme, relay 120 may operate in the half-duplex mode, may receive modulation symbols from source node 110 during odd-numbered symbol periods, and may transmit output symbols to destination node 130 during even-numbered symbol periods. The processing by relay 120 may ensure that destination node 130 can receive Alamouti-encoded symbols from the two subcarriers in the two symbol periods. This can provide orthogonality between the modulation symbols transmitted by source node 110 and the output symbols transmitted by relay 120 at destination node 130. Destination node 130 may be able to obtain estimates of the modulation symbols independently based on a transmission from source node 110 and a transmission from relay 120.

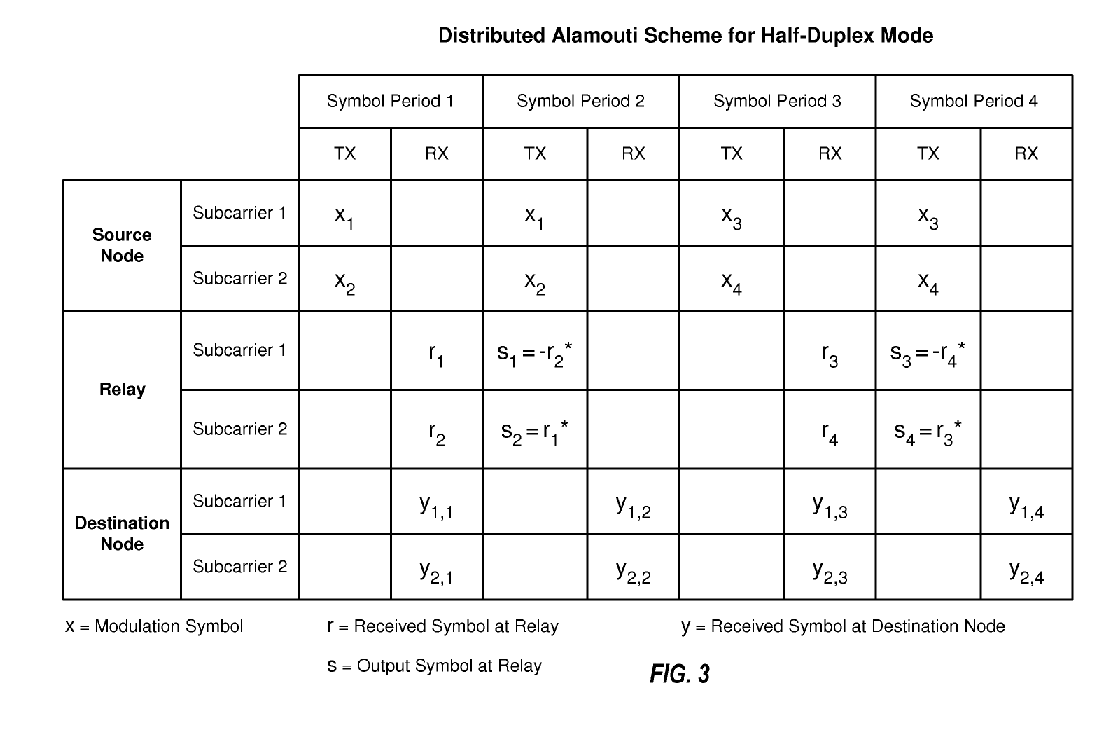

FIG. 3 illustrates operation of the distributed Alamouti scheme for the half-duplex mode. For simplicity, FIG. 3 shows transmitted symbols and received symbols on two subcarriers (Subcarrier 1 and Subcarrier 2) in four symbol periods (Symbol Periods 1-4). In general, the distributed Alamouti scheme may be used for any number of subcarriers and any number of symbol periods.

As the example of FIG. 3 shows, source node 110 may transmit a pair of modulation symbols xᵢ and xᵢ₊₁ on two subcarriers 1 and 2 in symbol period i and may transmit the same pair of modulation symbols on subcarriers 1 and 2 in the next symbol period i+1. Relay 120 may obtain two received symbols rᵢ and rᵢ₊₁ from the two subcarrier in symbol period i. Relay 120 may generate two output symbols sᵢ and sᵢ₊₁, as follows:

sᵢ=−r_{i±1}*, and Eq (40)

sᵢ₊₁=rᵢ*. Eq (41)

Relay 120 may transmit the two output symbols sᵢ and sᵢ₊₁ on the two subcarriers in the next symbol period i+1. Relay 120 may receive modulation symbols from source node 110 during odd-numbered symbol periods and may transmit output symbols to destination node 130 during even-numbered symbol periods. The output symbols transmitted in each symbol period are processed versions of the received symbols in the preceding symbol period.

Destination node 130 may obtain two received symbols y_{1,i} and y_{2,i} from two subcarriers 1 and 2 in symbol period i and may obtain two received symbols y_{1,i+1} and y_{2,i+1} from the two subcarriers 1 and 2 in symbol period i+1. Destination node 130 may determine estimates of modulation symbols xᵢ and xᵢ₊₁ transmitted by source node 110 based on the four received symbols y_{1,i}, y_{2,i}, y_{1,i+1} and y_{2,i+1}, as follows:

$$\begin{matrix}{\hat{x}}_{i} = \frac{{h}_{0}^{*} \cdot ( {y}_{1 , i} + {y}_{1 , i + 1} ) + {h}_{1}^{*} \cdot {h}_{2} \cdot {y}_{2 , i + 1}^{*}}{2 {\vert {h}_{0} \vert}^{2} + {\vert {h}_{1} \vert}^{2} \cdot {\vert {h}_{2} \vert}^{2}} , \\ and & Eq ( 42 ) \\ {\hat{x}}_{i + 1} = \frac{{h}_{0}^{*} \cdot ( {y}_{2 , i} + {y}_{2 , i + 1} ) + {h}_{1}^{*} \cdot {h}_{2} \cdot {y}_{1 , i + 1}^{*}}{2 {\vert {h}_{0} \vert}^{2} + {\vert {h}_{1} \vert}^{2} \cdot {\vert {h}_{2} \vert}^{2}} . & Eq ( 43 )\end{matrix}$$

In equation (42), the term y_{1,i}+y_{1,i+1} provides a first estimate of modulation symbol xᵢ based on desired signal components from source node 110 at destination node 130. The term y_{2,i+1} provides a second estimate of modulation symbol xᵢ based on desired signal components from relay 120 at destination node 130. The two estimates of modulation symbol xᵢ are multiplied by appropriate channel gains, coherently combined, and scaled to obtain a final estimate of modulation symbol xᵢ. An estimate of modulation symbol xᵢ₊₁ may be obtained in similar manner, as shown in equation (43).

In the distributed Alamouti scheme, the processing at relay 120 may ensure that destination node 130 observes Alamouti-encoded symbols across the two subcarriers. Destination node 130 may be able to determine estimates of modulation symbols xᵢ and xᵢ₊₁ independently due to the orthogonality provided by the Alamouti code.

In yet another aspect of the disclosure, a distributed Alamouti scheme across frequency may be used to support the full-duplex mode. In this transmission scheme, source node 110 may transmit two modulation symbols on two subcarriers in each of two consecutive symbol periods. The channel may be assumed to be static over the two symbol periods. Relay 120 may obtain two received symbols from the two subcarriers in one symbol period and may generate two output symbols based on the two received symbols. Relay 120 may then transmit the two output symbols on the two subcarriers in the next symbol period.

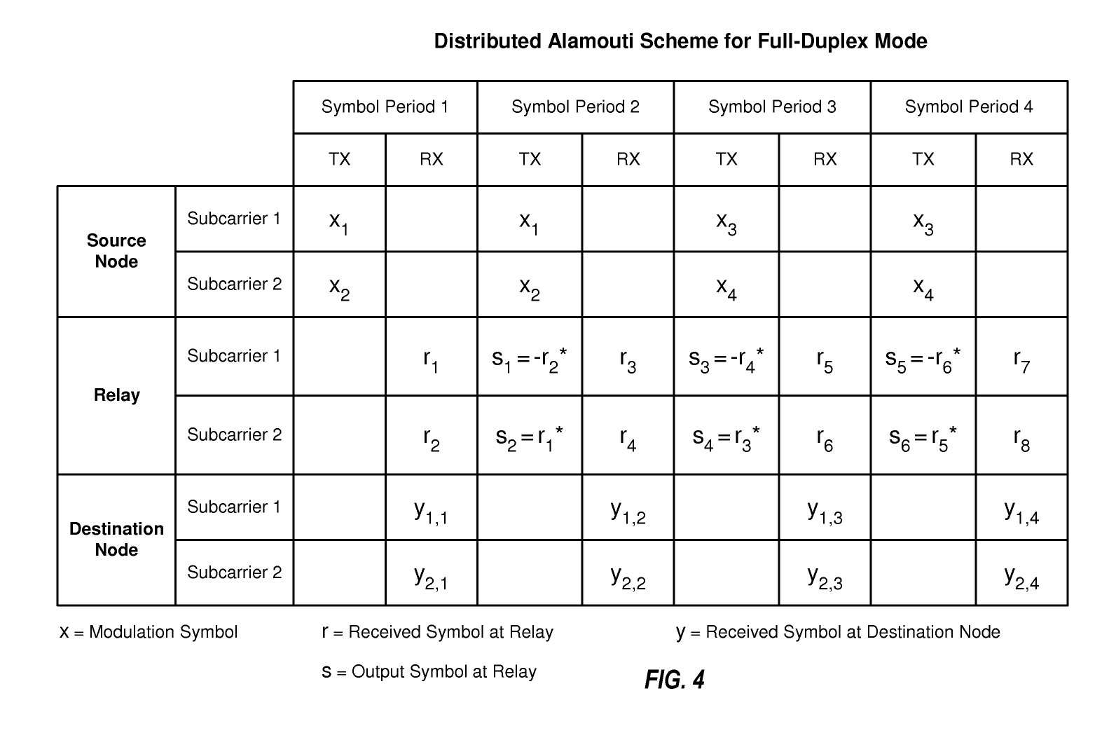

FIG. 4 illustrates operation of the distributed Alamouti scheme for the full-duplex mode. For simplicity, FIG. 4 shows transmitted symbols and received symbols on two subcarriers 1 and 2 in four symbol periods 1 to 4. In general, the distributed Alamouti scheme may be used for any number of subcarriers and any number of symbol periods.

As shown in FIG. 4, source node 110 may transmit a pair of modulation symbols xᵢ and xᵢ₊₁ on two subcarriers 1 and 2 in symbol period i and may transmit the same pair of modulation symbols on subcarriers 1 and 2 in the next symbol period i+1. Relay 120 may obtain two received symbols r₂ᵢ₋₁ and r₂ᵢ from the two subcarrier in symbol period i. Relay 120 may generate two output symbols s₂ᵢ₋₁ and s₂ᵢ, as follows:

s₂ᵢ₋₁=−r₂ᵢ*, and Eq (44)

s₂ᵢ=r₂ᵢ₋₁*. Eq (45)

Relay 120 may transmit the two output symbols s₂ᵢ₋₁ and s₂ᵢ on the two subcarriers in the next symbol period i+1.

Destination node 130 may obtain two received symbols y_{1,i} and y_{2,i} from two subcarriers 1 and 2 in symbol period i. Neglecting self-interference at relay 120, orthogonality may be preserved in even-numbered symbol periods. However, there may be crosstalk between certain symbols in odd-numbered symbol periods. The received symbols may be processed based on an MMSE receiver, a trellis-based receiver, or some other type of receiver to obtain estimates of the modulation symbols transmitted by source node 110.

FIGS. 2 to 4 show three exemplary designs of orthogonal schemes that support relay operation. Other orthogonal schemes may also be supported for relay operation. For example, an orthogonal scheme may obtain orthogonal signals by swapping the way in which an output signal is generated at a relay and a source node. In this orthogonal scheme, the source node may transmit a pair of symbols (a, −a), and the relay may transmit a pair of symbols (b, b).

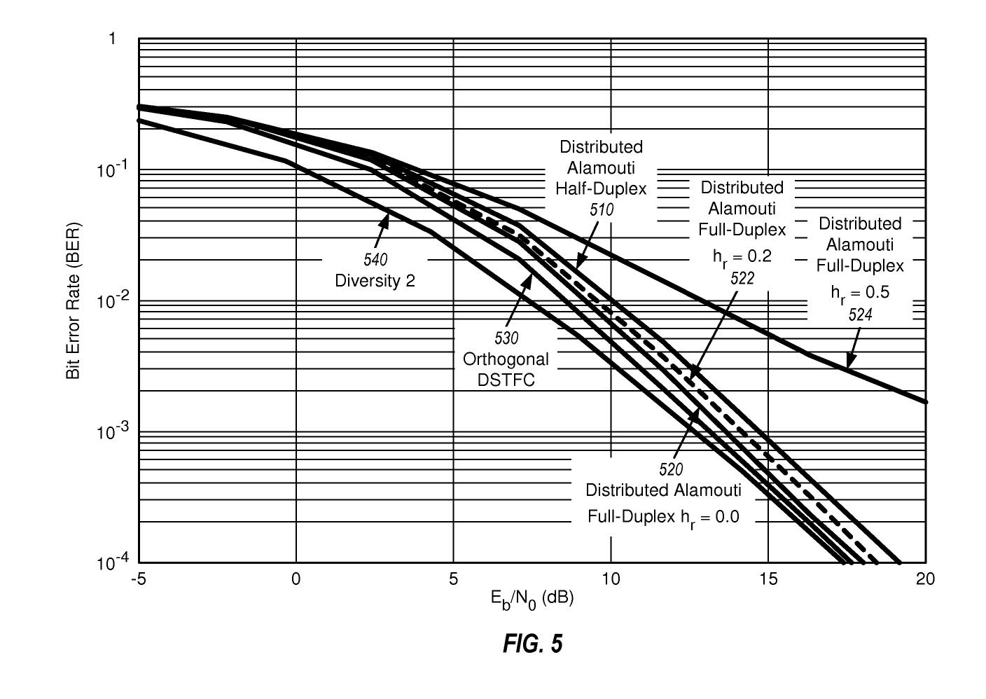

FIG. 5 shows an exemplary performance of the three transmission schemes described above in FIGS. 2 to 4. In FIG. 5, the horizontal axis denotes energy-per-bit-to-noise ratio (E_{b}/N₀), and the vertical axis denotes bit error rate (BER). E_{b} refers to the transmitted energy per bit at source node 110. The transmit power of relay 120 may be the same as the transmit power of source node 110.

A plot 510 shows the performance of the distributed Alamouti scheme for the half-duplex mode in FIG. 3. This transmission scheme does not suffer from self-interference but experiences some performance degradation since the relay is not able to transmit all the time. A plot 520 shows the performance of the distributed Alamouti scheme for the full-duplex mode in FIG. 4 for the case of hᵣ=0 and no self-interference at the relay. Plot 522 and 524 shows the performance of the distributed Alamouti scheme for the full-duplex mode for hᵣ=0.2 and hᵣ=0.5, respectively. Plots 520, 522 and 524 are obtained with an MMSE receiver at destination node 130. Plots 520, 522 and 524 indicate that modest gain over the half-duplex transmission scheme in FIG. 3 may be achieved if self-interference at relay 120 is moderate.

A plot 530 shows the performance of the orthogonal DSTFC scheme for the full-duplex mode in FIG. 3. The orthogonal DSTFC scheme does not suffer from self-interference at relay 120 and performs significantly better than the distributed Alamouti scheme in FIG. 3. The receiver noise at relay 120 is the main reason why the orthogonal DSTFC scheme diverges from a plot 540 for diversity 2. The detection complexity for the orthogonal DSTFC scheme is low and comparable to the detection complexity for the distributed Alamouti scheme in FIG. 3.

The orthogonal DSTFC scheme may provide the following advantages:
Provide better performance, e.g., as shown by the plots in FIG. 5,
Enable simple processing at relay 120 to generate output symbols,
Enable relay 120 to operate in the full-duplex mode without the need for good transmitter/receiver antenna separation at relay 120, which would enable better utilization of a channel,
Cancel self-interference at relay 120 without the need to know the channel response and/or the self-interfering signal at relay 120,
Preserve orthogonality of signal components from source node 110 and signal components from relay 120 at destination node 130, which may enable use of a low-complexity ML detector comprising a simple matched filter followed by a symbol-wise detector,
Provide low peak-to-average power ratio (PAPR) at source node 110 and relay 120,
Enable simple channel estimation for destination node 130, and
Avoid advanced gain control at relay 120.
   The distributed Alamouti schemes in FIGS. 3 and 4 may provide some of the advantages listed above.

It will be recognized that the transmission schemes described herein differ in several respects from conventional DSTC and DSTFC schemes. For example, with the transmission schemes described herein, the source node and the relay transmit their symbols on the same set of subcarriers whereas, in conventional DSTC and DSTFC schemes, the source node and the relay transmits their symbols on different overlapping sets of subcarriers. Furthermore, the DSTC and DSTFC schemes are limited to the half-duplex mode whereas the transmission schemes in FIGS. 2 and 4 can be used for the full-duplex mode. Further distinctions be apparent to the skilled person in light of the present disclosure.

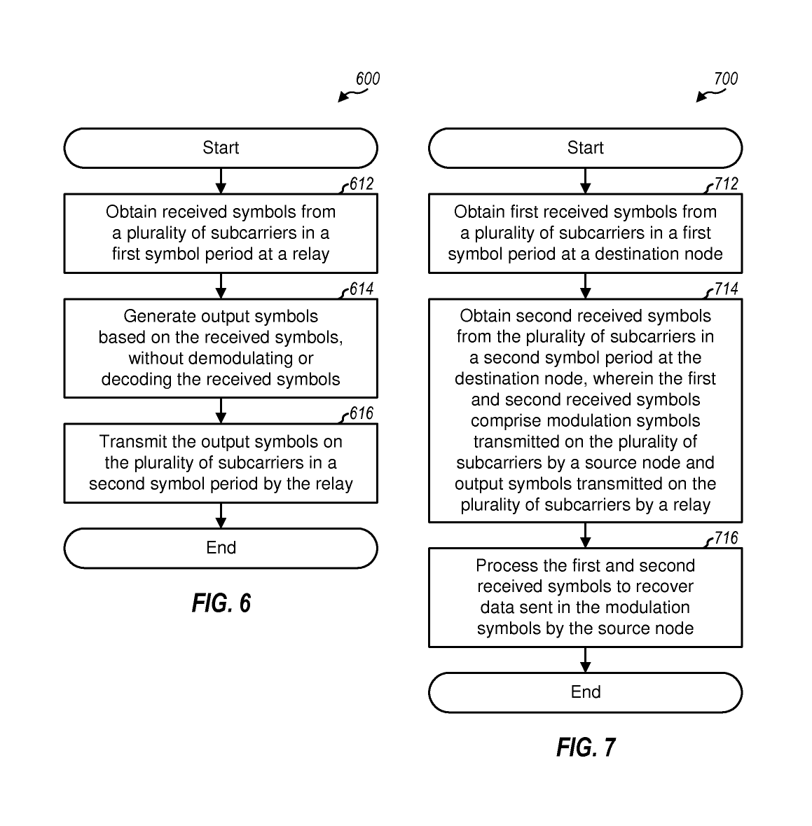

FIG. 6 shows a design of a process 600 for relaying transmissions in a wireless communication network. Process 600 may be performed by a relay (as described below) or by some other entity. The relay may obtain received symbols (e.g., received symbols r_{1,i} and r_{2,1} in FIG. 2) from a plurality of subcarriers in a first symbol period (block 612). The relay may generate output symbols (e.g., out symbols s_{1,2} and s_{2,2} in FIG. 2) based on the received symbols, without demodulating or decoding the received symbols (block 614). The relay may transmit the output symbols on the plurality of subcarriers in a second symbol period (block 616).

In one design, the relay may operate in a full-duplex mode and may concurrently receive and transmit on the plurality of subcarriers in each of a plurality of symbol periods including the first and second symbol periods, e.g., as shown in FIGS. 2 and 4. The relay may obtain additional received symbols (e.g., received symbols r_{1,2} and r_{2,2} in FIG. 2) from the plurality of subcarriers in the second symbol period, generate additional output symbols (e.g., output symbols s_{1,3} and s_{2,3} in FIG. 2) based on the additional received symbols, and transmit the additional output symbols on the plurality of subcarriers in a third symbol period.

In another design, the relay may operate in a half-duplex mode and may either receive or transmit on the plurality of subcarriers in each of the plurality of symbol periods, e.g., as shown in FIG. 3. The relay may obtain additional received symbols (e.g., received symbols r₃ and r₄ in FIG. 3) from the plurality of subcarriers in a third symbol period, generate additional output symbols (e.g., out symbols s₃ and s₄ in FIG. 3) based on the additional received symbols, and transmit the additional output symbols on the plurality of subcarriers in a fourth symbol period.

In one design, the orthogonal DSTFC scheme in FIG. 2 may be utilized. The plurality of subcarriers may include at least one pair of subcarriers. At least one modulation symbol may be transmitted by a source node on the at least one pair of subcarriers in each of the plurality of symbol periods. Each modulation symbol may be transmitted on one pair of subcarriers in one symbol period. For example, the plurality of subcarriers may include first and second subcarriers. A first modulation symbol x₁ may be transmitted by the source node on the first and second subcarriers in the first symbol period, and a second modulation symbol x₂ may be transmitted by the source node on the first and second subcarriers in the second symbol period.

In the orthogonal DSTFC scheme, the relay may generate two output symbols s_{1,2} and s_{2,2} based on two received symbols r_{1,1} and r_{2,1} from two subcarriers in the first symbol period, e.g., as shown in equations (1) and (2). The relay may generate each output symbol based on a sum of the two received symbols from the two subcarriers in the first symbol period. One of the two output symbols may be a negative of the other one of the two output symbols. For example, the relay may obtain a first received symbol r_{1,1} from a first subcarrier in the first symbol period and may obtain a second received symbol r_{2,1} from a second subcarrier in the first symbol period. The relay may generate a first output symbol s_{1,2} based on a sum of the first and second received symbols, as shown in equation (1), and may generate a second output symbol s_{2,2} based on a negative of the sum of the first and second received symbols, as shown in equation (2). The relay may transmit the first output symbol on the first subcarrier in the second symbol period and may transmit the second output symbol on the second subcarrier in the second symbol period.

In general, for the orthogonal DSTFC scheme, the relay may generate output symbols based on a unitary matrix V selected to reduce/mitigate self-interference at the relay. A processing matrix uᵣ may be defined based on the unitary matrix V, e.g., as shown in equation (14) or (15). The relay may generate the output symbols based on the received symbols and the processing matrix uᵣ, e.g., as shown in equations (10) and (11). The relay may generate the output symbols to be orthogonal to the modulation symbols transmitted by the source node at the relay and also at a destination node receiving transmissions from the source node and the relay.

In another design, the distributed Alamouti scheme for the half-duplex mode in FIG. 3 or the full-duplex mode in FIG. 4 may be utilized. A plurality of modulation symbols may be transmitted by the source node on the plurality of subcarriers in the first symbol period and also on the plurality of subcarriers in the second symbol period. Each modulation symbol may be transmitted on one subcarrier in two symbol periods. The relay may generate each output symbol based on a function of one received symbol, e.g., as shown in equations (40) and (41) or equations (44) and (45). The function may comprise a complex conjugate and/or a sign inversion. For example, the relay may obtain a first received symbol r₁ from the first subcarrier in the first symbol period and may obtain a second received symbol r₂ from the second subcarrier in the first symbol period. The relay may generate a first output symbol s₁ based on a negative of a complex conjugate of the second received symbol, as shown in equation (40). The relay may generate a second output symbol s₂ based on a complex conjugate of the first received symbol, as shown in equation (41). The relay may transmit the first output symbol on the first subcarrier in the second symbol period and may transmit the second output symbol on the second subcarrier in the second symbol period.

In the distributed Alamouti scheme for the half-duplex mode in FIG. 3, the relay may obtain received symbols from the plurality of subcarriers in odd-numbered symbol periods. The relay may generate output symbols for even-numbered symbol periods based on the received symbols obtained in the odd-numbered symbol periods. The relay may transmit the output symbols for the even-numbered symbol periods on the plurality of subcarriers in the even-numbered symbol periods.

For the distributed Alamouti scheme for the full-duplex mode in FIG. 4, the relay may obtain received symbols from the plurality of subcarriers in each of a plurality of symbol periods. The relay may generate output symbols for each symbol period based on the received symbols obtained in that symbol period. The relay may transmit the output symbols for each symbol period on the plurality of subcarriers in a subsequent symbol period.

Advantageously, in each of the transmission schemes described herein, the relay may generate the output symbols without using a channel estimate. The relay may generate output symbols for a single transmit antenna at the relay, as described above. Alternatively, the relay may precode the output symbols based on a precoding matrix to send each output symbol from a plurality of antennas at the relay.

FIG. 7 shows a design of a process 700 for receiving data in a wireless communication network. Process 700 may be performed by a destination node (as described below) or by some other entity. The destination node may obtain first received symbols (e.g., received symbols y_{1,1} and y_{2,1} in FIG. 2) from a plurality of subcarriers in a first symbol period (block 712). The destination node may also obtain second received symbols (e.g., received symbols y_{1,2} and y_{2,2} in FIG. 2) from the plurality of subcarriers in a second symbol period (block 714). The first and second received symbols may comprise (i) modulation symbols transmitted on the plurality of subcarriers by a source node and (ii) output symbols transmitted on the plurality of subcarriers by a relay. The output symbols may be generated by the relay based on third received symbols at the relay, without demodulating or decoding the third received symbols by the relay. The destination node may process the first and second received symbols to recover data sent in the modulation symbols by the source node (block 716).

In one design, the orthogonal DSTFC scheme in FIG. 2 may be utilized. The plurality of subcarriers may include at least one pair of subcarriers. At least one modulation symbol may be transmitted by the source node on the at least one pair of subcarriers in each of a plurality of symbol periods including the first and second symbol periods. Each modulation symbol may be transmitted on one pair of subcarriers in one symbol period. For example, a modulation symbol x₁ may be transmitted by the source node on two subcarriers in the first symbol period. Two output symbols s_{1,2} and s_{2,2} may be generated by the relay based on two received symbols r_{1,1} and r_{2,1} obtained by the relay from the two subcarriers in the first symbol period and may be transmitted by the relay in the second symbol period.

In one design of block 716 for the orthogonal DSTFC scheme, the destination node may determine an estimate of the modulation symbol x₁ based on a sum of two first received symbols (e.g., received symbols y_{1,1} and y_{2,1} in FIG. 2) from the two subcarriers in the first symbol period, e.g., as shown in equation (7). The destination node may determine the estimate of the modulation symbol based further on a difference of two second received symbols (e.g., received symbols y_{1,2} and y_{2,2} in FIG. 2) from the two subcarriers in the second symbol period, e.g., as also shown in equation (7).

In another design of block 716 for the orthogonal DSTFC scheme, the destination node may determine a filter matrix based on a channel matrix, e.g., as shown in equation (35). The destination node may also determine the filter matrix based further on a noise estimate and in accordance with a MMSE criterion, e.g., as shown in equation (37). The destination node may determine estimates of modulation symbols transmitted by the source node based on the filter matrix and the first and second received symbols, e.g., as shown in equation (36) or (39).

In another design, the distributed Alamouti scheme in FIG. 3 or 4 may be utilized. Two modulation symbols (e.g., modulation symbols x₁ and x₂ in FIG. 3) may be transmitted by the source node on two subcarriers in each of the first and second symbol periods. Each modulation symbol may be transmitted on one subcarrier in two symbol periods. For the half-duplex mode in FIG. 3, two output symbols (e.g., output symbols s₁ and s₂ in FIG. 3) may be (i) generated by the relay based on two received symbols (e.g., received symbols r₁ and r₂ in FIG. 3) obtained by the relay from the two subcarriers in the first symbol period and (ii) transmitted by the relay in the second symbol period. For the full-duplex mode in FIG. 4, two additional output symbols (e.g., output symbols s₃ and s₄ in FIG. 4) may be (i) generated by the relay based on two received symbols (e.g., received symbols r₃ and r₄ in FIG. 4) obtained by the relay from the two subcarriers in the second symbol period and (ii) transmitted by the relay in a third symbol period.

In one design of block 716 for the distributed Alamouti scheme, the destination node may determine estimates of two modulation symbols (e.g., modulation symbols x₁ and x₂) based on two first received symbols (e.g., received symbols y_{1,1} and y_{2,1}) obtained from the two subcarriers in the first symbol period and two second received symbols (e.g., received symbols y_{1,2} and y_{2,2}) obtained from the two subcarriers in the second symbol period, e.g., as shown in equations (42) and (43). In another design of block 716 for the distributed Alamouti scheme, the destination node may determine estimates of modulation symbols based on the received symbols using an ML receiver, an MMSE receiver, a trellis-based receiver, or some other type of receiver.

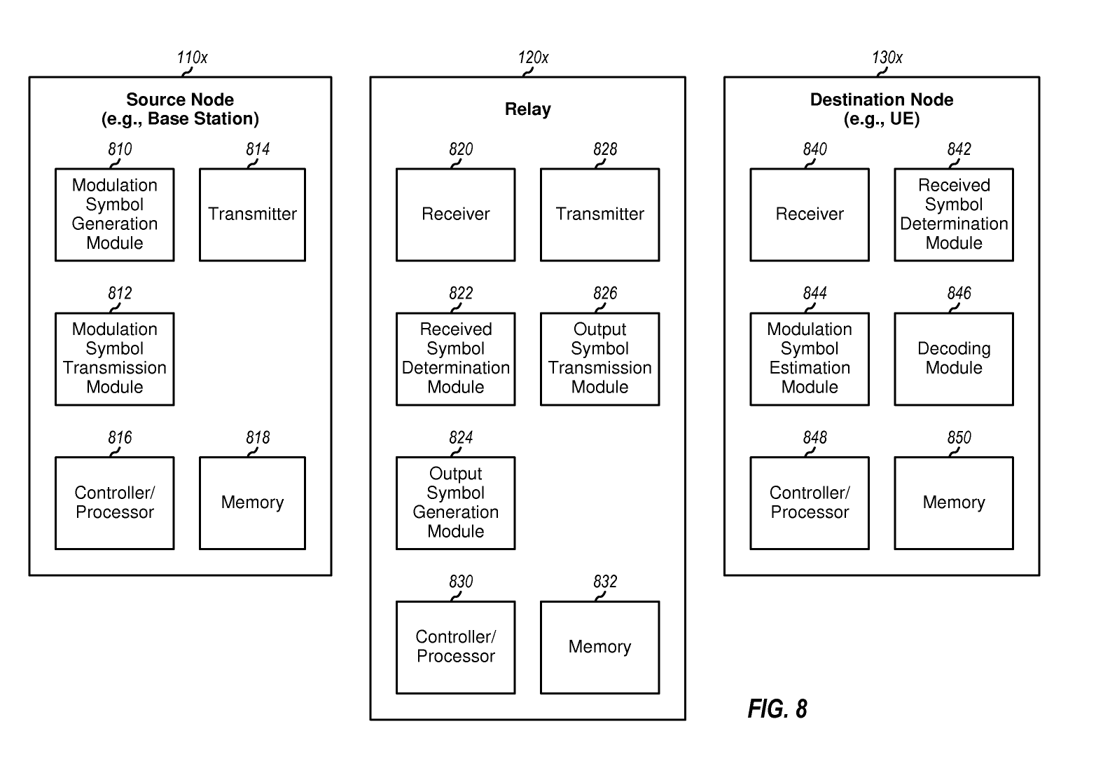

FIG. 8 shows a block diagram of a source node 110x, a relay 120x, and a destination node 130x, which is one design of source node 110, relay 120, and destination node 130 in FIG. 1. Within source node 110x, a module 810 may generate modulation symbols for data to transmit to destination node 130x. Module 810 may also generate reference symbols for a reference signal. Module 810 may include an encoder, an interleaver, a symbol mapper, etc. A module 812 may generate a transmission comprising the modulation symbols, the reference symbols, etc. Module 812 may include a precoder (if source node 110x includes multiple antennas), a modulator (e.g., for OFDM, SC-FDMA, CDMA, etc.), and/or other processing blocks. A transmitter 814 may generate a source signal comprising the transmission being sent by source node 110x. A controller/processor 816 may direct the operation of various modules within source node 110x. A memory 818 may store data and program codes for source node 110x.

Within relay 120x, a receiver 820 may receive the source signal transmitted by source node 110x and a relay signal transmitted by relay 120x and may provide one or more received signals. A module 822 may determine received symbols based on the received signal(s) from receiver 820. A module 824 may generate output symbols based on the received symbols, as described above. A module 826 may generate a transmission comprising the output symbols, reference symbols, etc. A transmitter 828 may generate the relay signal comprising the transmission being sent by relay 120x. A controller/processor 830 may direct the operation of various modules within relay 120x. A memory 832 may store data and program codes for relay 120x.

Within destination node 130x, a receiver 840 may receive the source signal transmitted by source node 110x and the relay signal transmitted by relay 120x and may provide one or more received signals. A module 842 may determine received symbols based on the received signal(s) from receiver 840. A module 844 may determine estimates of the modulation symbols transmitted by source node 110x, as described above. A module 846 may process (e.g., decode) the estimates of the modulation symbol to recover data sent by source node 110x to destination node 130x. A controller/processor 848 may direct the operation of various modules within destination node 130x. A memory 850 may store data and program codes for destination node 130x.

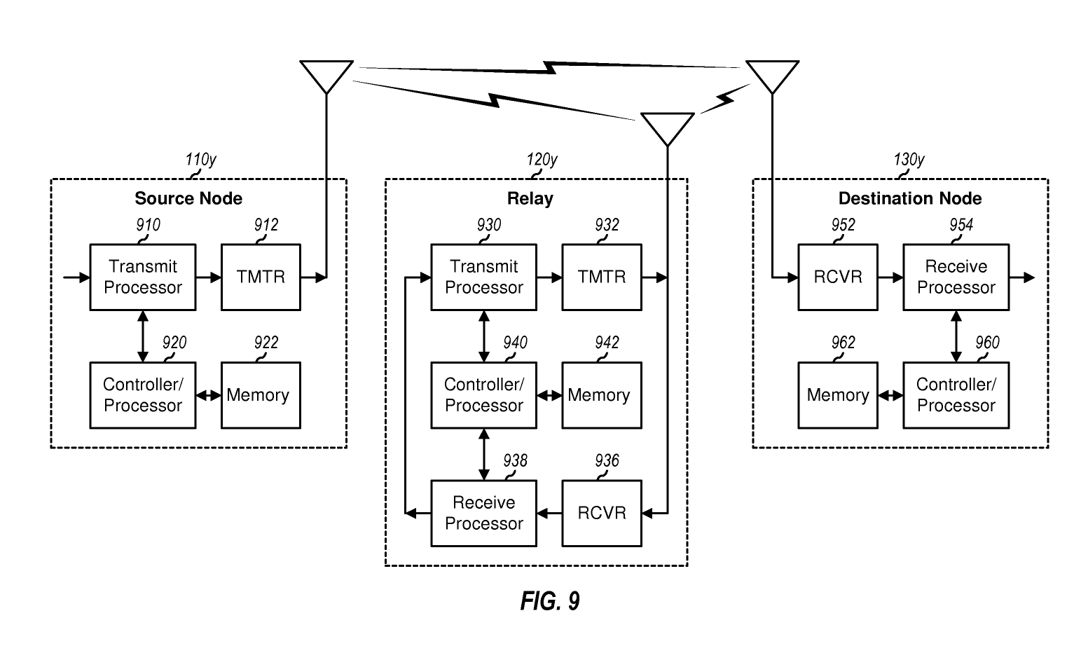

FIG. 9 shows a block diagram of a source node 110y, a relay 120y, and a destination node 130y, which is another design of source node 110, relay 120, and destination node 130 in FIG. 1.

At source node 110y, a transmit processor 910 may receive data to transmit and may process (e.g., encode and modulate) the data in accordance with a selected modulation and coding scheme (MCS) to obtain modulation symbols. Processor 910 may also process control information to obtain control symbols. Processor 910 may multiplex the modulation symbols, the control symbols, and reference symbols (e.g., on different subcarriers and/or in different symbol periods). Processor 910 may further process the multiplexed symbols (e.g., for OFDM, SC-FDMA, etc.) to generate output samples. A transmitter (TMTR) 912 may condition (e.g., convert to analog, amplify, filter, and upconvert) the output samples to generate a source signal, which may be transmitted to relay 120y and destination node 130y.

At relay 120y, a receiver (RCVR) 936 may receive the source signal from source node 110y. Receiver 936 may condition (e.g., filter, amplify, downconvert, and digitize) the received signal and provide received samples. A receive processor 938 may process the received samples to obtain received symbols from different subcarriers. A transmit processor 930 may generate output symbols based on the received symbols and in accordance with any of the transmission schemes described above. A transmitter 932 may condition the output symbols from processor 930 and generate a relay signal, which may be transmitted to destination node 130y.

At destination node 130y, the source signal from source node 110y and the relay signal from relay 120y may be received and conditioned by a receiver 952 and further processed by a receive processor 954 to obtain estimates of the modulation symbols transmitted by source node 110y. Processor 954 may derive channel estimates, derive a filter matrix, and perform filtering of the received symbols with the filter matrix. Processor 954 may further process (e.g., demodulate and decode) the estimates of the modulation symbols to recover the data and control information sent by source node 110y.

Controllers/processors 920, 940 and 960 may direct operation at source node 110y, relay 120y, and destination node 130y, respectively. Controller/processor 940 at relay 120y may perform or direct process 600 in FIG. 6 and/or other processes for the techniques described herein. Controller/processor 960 at destination node 130y may perform or direct process 700 in FIG. 7 and/or other processes for the techniques described herein. Memories 922, 942 and 962 may store data and program codes for source node 110y, relay 120y, and destination node 130y, respectively.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method for wireless communication, comprising:
obtaining received symbols from a plurality of subcarriers in a first symbol period at a relay;
generating output symbols based on the received symbols, without demodulating or decoding the received symbols; and
transmitting the output symbols on the plurality of subcarriers in a second symbol period by the relay.

2. The method of claim 1, wherein the relay operates in a full-duplex mode and concurrently receives and transmits on the plurality of subcarriers in each of a plurality of symbol periods including the first and second symbol periods.

3. The method of claim 1, further comprising:
obtaining additional received symbols from the plurality of subcarriers in the second symbol period at the relay;
generating additional output symbols based on the additional received symbols; and
transmitting the additional output symbols on the plurality of subcarriers in a third symbol period by the relay.

4. The method of claim 1, wherein the relay operates in a half-duplex mode and either receives or transmits on the plurality of subcarriers in each of a plurality of symbol periods including the first and second symbol periods.

5. The method of claim 1, wherein the generating the output symbols comprises generating the output symbols to be orthogonal to modulation symbols transmitted by the source node at the relay.

6. The method of claim 1, wherein the generating the output symbols comprises generating the output symbols to be orthogonal to modulation symbols transmitted by the source node at a destination node receiving transmissions from the source node and the relay.

7. The method of claim 1, wherein the plurality of subcarriers include at least one pair of subcarriers, and wherein at least one modulation symbol is transmitted by a source node on the at least one pair of subcarriers in each of a plurality of symbol periods including the first and second symbol periods, with each modulation symbol being transmitted on one pair of subcarriers in one symbol period.

8. The method of claim 1, wherein the generating the output symbols comprises generating each output symbol based on a sum of two received symbols from two subcarriers in one symbol period.

9. The method of claim 1, wherein the generating the output symbols comprises generating two output symbols based on two received symbols from two subcarriers in the first symbol period, one of the two output symbols being a negative of the other one of the two output symbols.

10. The method of claim 1, wherein the plurality of subcarriers include first and second subcarriers, wherein a first modulation symbol is transmitted by a source node on the first and second subcarriers in the first symbol period, and wherein a second modulation symbol is transmitted by the source node on the first and second subcarriers in the second symbol period.

11. The method of claim 10, wherein the obtaining the received symbols comprises obtaining a first received symbol from the first subcarrier in the first symbol period, and obtaining a second received symbol from the second subcarrier in the first symbol period,
wherein the generating the output symbols comprises generating a first output symbol based on a sum of the first and second received symbols, and generating a second output symbol based on a negative of the sum of the first and second received symbols, and
wherein the transmitting the output symbols comprises transmitting the first output symbol on the first subcarrier in the second symbol period, and transmitting the second output symbol on the second subcarrier in the second symbol period.

12. The method of claim 1, wherein the generating the output symbols comprises generating the output symbols based on a unitary matrix selected to reduce self-interference at the relay.

13. The method of claim 1, wherein a plurality of modulation symbols are transmitted by a source node on the plurality of subcarriers in the first symbol period and also on the plurality of subcarriers in the second symbol period, with each modulation symbol being transmitted on one subcarrier in two symbol periods.

14. The method of claim 1, wherein the generating the output symbols comprises generating each output symbol based on a function of one received symbol, the function comprising a complex conjugate, or a sign inversion, or both.

15. The method of claim 1,
wherein the obtaining the received symbols comprises obtaining a first received symbol from the first subcarrier in the first symbol period, and obtaining a second received symbol from the second subcarrier in the first symbol period,
wherein the generating the output symbols comprises generating a first output symbol based on a negative of a complex conjugate of the second received symbol, and generating a second output symbol based on a complex conjugate of the first received symbol, and
wherein the transmitting the output symbols comprises transmitting the first output symbol on the first subcarrier in the second symbol period, and transmitting the second output symbol on the second subcarrier in the second symbol period.

16. The method of claim 1, wherein the relay operates in a half-duplex mode, the method further comprising:
obtaining received symbols from the plurality of subcarriers in odd-numbered symbol periods;
generating output symbols for even-numbered symbol periods based on the received symbols obtained in the odd-numbered symbol periods; and
transmitting the output symbols for the even-numbered symbol periods on the plurality of subcarriers in the even-numbered symbol periods.

17. The method of claim 1, wherein the relay operates in a full-duplex mode, the method further comprising:
obtaining received symbols from the plurality of subcarriers in each of a plurality of symbol periods including the first and second symbol periods;
generating output symbols for each of the plurality of symbol periods based on the received symbols obtained in said each symbol period; and
transmitting the output symbols for each symbol period on the plurality of subcarriers in a subsequent symbol period.

18. The method of claim 1, wherein the generating the output symbols comprises generating the output symbols by the relay without using a channel estimate.

19. The method of claim 1, wherein the generating the output symbols comprises precoding the output symbols based on a precoding matrix to send each output symbol from a plurality of antennas at the relay.

20. An apparatus for wireless communication, comprising:
at least one processor configured to:
obtain received symbols from a plurality of subcarriers in a first symbol period at a relay;
generate output symbols based on the received symbols, without demodulating or decoding the received symbols; and
send the output symbols on the plurality of subcarriers in a second symbol period by the relay.

21. The apparatus of claim 20, wherein the at least one processor is further configured to:
obtain additional received symbols from the plurality of subcarriers in the second symbol period at the relay;
generate additional output symbols based on the additional received symbols; and
send the additional output symbols on the plurality of subcarriers in a third symbol period by the relay.

22. The apparatus of claim 20, wherein the plurality of subcarriers include at least one pair of subcarriers, and wherein at least one modulation symbol is transmitted by a source node on the at least one pair of subcarriers in each of a plurality of symbol periods including the first and second symbol periods, with each modulation symbol being transmitted on one pair of subcarriers in one symbol period.

23. The apparatus of claim 20, wherein a plurality of modulation symbols are transmitted by a source node on the plurality of subcarriers in the first symbol period and also on the plurality of subcarriers in the second symbol period, with each modulation symbol being transmitted on one subcarrier in two symbol periods.

24. The apparatus of claim 20, wherein the relay operates in a half-duplex mode, and wherein the at least one processor is further configured to:
obtain received symbols from the plurality of subcarriers in odd-numbered symbol periods;
generate output symbols for even-numbered symbol periods based on the received symbols obtained in the odd-numbered symbol periods; and
send the output symbols for the even-numbered symbol periods on the plurality of subcarriers in the even-numbered symbol periods.

25. The apparatus of claim 20, wherein the relay operates in a full-duplex mode, and wherein the at least one processor is further configured to:
obtain received symbols from the plurality of subcarriers in each of a plurality of symbol periods including the first and second symbol periods;
generate output symbols for each of the plurality of symbol periods based on the received symbols obtained in said each symbol period; and
send the output symbols for each symbol period on the plurality of subcarriers in a subsequent symbol period.

26. An apparatus for wireless communication, comprising:
means for obtaining received symbols from a plurality of subcarriers in a first symbol period at a relay;
means for generating output symbols based on the received symbols, without demodulating or decoding the received symbols; and
means for transmitting the output symbols on the plurality of subcarriers in a second symbol period by the relay.

27. The apparatus of claim 26, further comprising:
means for obtaining additional received symbols from the plurality of subcarriers in the second symbol period at the relay;
means for generating additional output symbols based on the additional received symbols; and
means for transmitting the additional output symbols on the plurality of subcarriers in a third symbol period by the relay.

28. The apparatus of claim 26, wherein the plurality of subcarriers include at least one pair of subcarriers, and wherein at least one modulation symbol is transmitted by a source node on the at least one pair of subcarriers in each of a plurality of symbol periods including the first and second symbol periods, with each modulation symbol being transmitted on one pair of subcarriers in one symbol period.

29. The apparatus of claim 26, wherein a plurality of modulation symbols are transmitted by a source node on the plurality of subcarriers in the first symbol period and also on the plurality of subcarriers in the second symbol period, with each modulation symbol being transmitted on one subcarrier in two symbol periods.

30. The apparatus of claim 26, wherein the relay operates in a half-duplex mode, the apparatus further comprising:
means for obtaining received symbols from the plurality of subcarriers in odd-numbered symbol periods;
means for generating output symbols for even-numbered symbol periods based on the received symbols obtained in the odd-numbered symbol periods; and
means for transmitting the output symbols for the even-numbered symbol periods on the plurality of subcarriers in the even-numbered symbol periods.

31. The apparatus of claim 26, wherein the relay operates in a full-duplex mode, the apparatus further comprising:
means for obtaining received symbols from the plurality of subcarriers in each of a plurality of symbol periods including the first and second symbol periods;
means for generating output symbols for each of the plurality of symbol periods based on the received symbols obtained in said each symbol period; and
means for transmitting the output symbols for each symbol period on the plurality of subcarriers in a subsequent symbol period.

32. A computer program product, comprising:
a non-transitory computer-readable medium comprising:
code for causing at least one computer to obtain received symbols from a plurality of subcarriers in a first symbol period at a relay;
code for causing the at least one computer to generate output symbols based on the received symbols, without demodulating or decoding the received symbols; and
code for causing the at least one computer to send the output symbols on the plurality of subcarriers in a second symbol period by the relay.

33. A method for wireless communication, comprising:
obtaining first received symbols from a plurality of subcarriers in a first symbol period at a destination node;
obtaining second received symbols from the plurality of subcarriers in a second symbol period at the destination node, wherein the first and second received symbols comprise modulation symbols transmitted on the plurality of subcarriers by a source node and output symbols transmitted on the plurality of subcarriers by a relay; and
processing the first and second received symbols to recover data sent in the modulation symbols by the source node.

34. The method of claim 33, wherein a modulation symbol is transmitted by the source node on two subcarriers in the first symbol period, and wherein two output symbols are generated by the relay based on two received symbols obtained by the relay from the two subcarriers in the first symbol period and are transmitted by the relay in the second symbol period.

35. The method of claim 33, wherein the processing the first and second received symbols comprises determining an estimate of the modulation symbol based on a sum of two first received symbols obtained from the two subcarriers in the first symbol period.

36. The method of claim 35, wherein the processing the first and second received symbols further comprises determining the estimate of the modulation symbol based further on a difference of two second received symbols obtained from the two subcarriers in the second symbol period.

37. The method of claim 33, wherein the processing the first and second received symbols comprises
determining a filter matrix based on a channel matrix, and
determining estimates of modulation symbols transmitted by the source node based on the filter matrix and the first and second received symbols.

38. The method of claim 37, wherein the determining the filter matrix comprises determining the filter matrix based further on a noise estimate and in accordance with a minimum mean square error (MMSE) criterion.

39. The method of claim 33, wherein two modulation symbols are transmitted by the source node on two subcarriers in each of the first and second symbol periods, with each modulation symbol being transmitted on one subcarrier in two symbol periods, and wherein two output symbols are generated by the relay based on two received symbols obtained by the relay from the two subcarriers in the first symbol period and are transmitted by the relay in the second symbol period.

40. The method of claim 39, wherein two additional output symbols are generated by the relay based on two received symbols obtained by the relay from the two subcarriers in the second symbol period and are transmitted by the relay in a third symbol period.

41. The method of claim 33, wherein the processing the first and second received symbols comprises determining estimates of the two modulation symbols based on two first received symbols obtained from the two subcarriers in the first symbol period and two second received symbols obtained from the two subcarriers in the second symbol period.

42. The method of claim 40, wherein the processing the first and second received symbols comprises determining estimates of the two modulation symbols based on a minimum mean square error (MMSE) receiver.

43. An apparatus for wireless communication, comprising:
at least one processor configured to:
obtain first received symbols from a plurality of subcarriers in a first symbol period at a destination node;
obtain second received symbols from the plurality of subcarriers in a second symbol period at the destination node, wherein the first and second received symbols comprise modulation symbols transmitted on the plurality of subcarriers by a source node and output symbols transmitted on the plurality of subcarriers by a relay; and
process the first and second received symbols to recover data sent in the modulation symbols by the source node.

44. The apparatus of claim 43, wherein the at least one processor is configured to determine an estimate of the modulation symbol based on a sum of two first received symbols obtained from the two subcarriers in the first symbol period.

45. The apparatus of claim 43, wherein the at least one processor is configured to:
determine a filter matrix based on a channel matrix, and
determine estimates of modulation symbols transmitted by the source node based on the filter matrix and the first and second received symbols.

46. The apparatus of claim 43, wherein the at least one processor is configured to determine estimates of the two modulation symbols based on two first received symbols obtained from the two subcarriers in the first symbol period and two second received symbols obtained from the two subcarriers in the second symbol period.

47. An apparatus for wireless communication, comprising:
means for obtaining first received symbols from a plurality of subcarriers in a first symbol period at a destination node;
means for obtaining second received symbols from the plurality of subcarriers in a second symbol period at the destination node, wherein the first and second received symbols comprise modulation symbols transmitted on the plurality of subcarriers by a source node and output symbols transmitted on the plurality of subcarriers by a relay; and
means for processing the first and second received symbols to recover data sent in the modulation symbols by the source node.

48. The apparatus of claim 47, wherein the means for processing the first and second received symbols comprises means for determining an estimate of the modulation symbol based on a sum of two first received symbols obtained from the two subcarriers in the first symbol period.

49. The apparatus of claim 47, wherein the means for processing the first and second received symbols comprises
means for determining a filter matrix based on a channel matrix, and
means for determining estimates of modulation symbols transmitted by the source node based on the filter matrix and the first and second received symbols.

50. The apparatus of claim 47, wherein the means for processing the first and second received symbols comprises means for determining estimates of the two modulation symbols based on two first received symbols obtained from the two subcarriers in the first symbol period and two second received symbols obtained from the two subcarriers in the second symbol period.

51. A computer program product, comprising:
a non-transitory computer-readable medium comprising:
code for causing at least one computer to obtain first received symbols from a plurality of subcarriers in a first symbol period at a destination node;
code for causing the at least one computer to obtain second received symbols from the plurality of subcarriers in a second symbol period at the destination node, wherein the first and second received symbols comprise modulation symbols transmitted on the plurality of subcarriers by a source node and output symbols transmitted on the plurality of subcarriers by a relay; and
code for causing the at least one computer to process the first and second received symbols to recover data sent in the modulation symbols by the source node.
